(19) United States
(12) Patent Application Publication
(10) Pub. No.: US 2026/0301103 A1
(43) Pub. Date: Oct. 1, 2026

(54) LOCKER MANAGEMENT SYSTEMS AND METHODS

(71) Applicant: Universal City Studios LLC, Universal City, CA (US)

(72) Inventors: Scot Burklin, Orlando, FL (US); Gregory Paul Habiak, Orlando, FL (US)

(21) Appl. No.: 19/095,965

(22) Filed: Mar. 31, 2025

(51) Int. Cl. G06Q 90/00; G06Q 10/02

(52) U.S. Cl. CPC G06Q 90/20; G06Q 10/02

(57) ABSTRACT

A locker system for an entertainment venue includes a frame, one or more lockers housed within the frame, a lighting system, and a registering device that may receive a request for a locker assignment from a guest. The system also includes a processing system including one or more processors and memory storing instructions that, when executed by the processing system, cause the processing system to assign a reserved locker of the one or more lockers to the guest based on the request and activate a locker guidance module to control illumination of the lighting system to define a path from the registering device to the reserved locker.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks or similar entertainment venues often include one or more locker systems, such that guests (and personnel) may store their belongings in the lockers while at the amusement park. However, it may be time consuming to find or register for an available locker among a large number of lockers. In addition, it may be challenging to efficiently provide suitable lockers to a large number of guests seeking lockers at the same time. Accordingly, it would be desirable to provide efficient systems and methods for guiding users to their assigned or rented lockers.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a locker system for an entertainment venue includes a frame, one or more lockers housed within the frame, a lighting system, and a registering device that may receive a request for a locker assignment from a guest. The system also includes a processing system including one or more processors, and memory storing instructions that, when executed by the processing system, cause the processing system to assign a reserved locker of the one or more lockers to the guest based on the request and activate a locker guidance module to control illumination of the lighting system to define a path from the registering device to the reserved locker.

In an embodiment, a locker system for storing belongings includes one or more lockers, a registering device to assign a reserved locker of the one or more lockers to a guest and locker displays positioned on the outside of the one or more lockers. The system also includes a processing system including one or more processors and memory storing instructions that, when executed by the processing system, cause the processing system to display, via the locker displays, guiding imagery to direct the guest from the registering device to the reserved locker.

In an embodiment, a locker system for an entertainment venue includes a frame, one or more lockers housed within the frame, a lighting system, and a controller communicatively coupled to the lighting system. The controller includes a processing system including one or more processors and memory storing instructions that, when executed by the processing system, cause the processing system to assign a reserved locker of the one or more lockers to a guest based on a request; and generate a path using the lighting system, where the path extends towards the reserved locker.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a locker system in an entertainment venue, in accordance with an aspect of the present disclosure;

FIG. 2 is a schematic diagram of an embodiment of the locker system, in accordance with an aspect of the present disclosure;

FIG. 3 is a schematic diagram of an embodiment of the locker system, in accordance with an aspect of the present disclosure;

FIG. 4 is a schematic diagram of an embodiment of the locker system, in accordance with an aspect of the present disclosure;

FIG. 5 is a schematic diagram of an embodiment of the locker system, in accordance with an aspect of the present disclosure; and

FIG. 6 is a schematic diagram of an embodiment of the locker system, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is presently recognized that guests of an entertainment venue may participate in various attractions, such as rides, walkthrough attractions, and show performances, throughout the entertainment venue. Many attractions may restrict guests from carrying personal belongings, such as mobile devices, bags, keys, etc., during operation or run time of the attraction. As such, lockers may be positioned near attractions, such as at the entry or exit, to enable guests to safely store their belongings during the operation or run time of the attraction. Unfortunately, it may be time consuming for guests to find or register for an available locker among a large number of lockers. Additionally, it may be challenging to efficiently provide suitable lockers to a large number of guests seeking lockers at the same time.

The present disclosure is directed to a locker system operable to provide directional assistance to a guest after the guest has been assigned a locker to store belongings. For example, the locker system may include a registering device (e.g., kiosk, user interface on a mobile device, etc.) and one or more lockers operable to store guest belongings. The registering device may enable guests to reserve available lockers for storage of personal belongings during participation in an attraction of an entertainment venue. The locker system may further include a lighting system operable to illuminate to efficiently direct guests from the registering device to the reserved locker. The lighting system may include lights (e.g., LED lights, addressable LED lights, array of lights), displays (e.g., visual displays, LED displays, etc.), or both. Further, in accordance with present embodiments, the lights may be positioned to facilitate wayfinding (e.g., wayfinding for individuals or multiple people at the same time), to provide operational efficiency (e.g., allowing for multiple uses of light strands to direct to different locations), to avoid interference with access or viewing of the lights, and so forth. For example, the lights may be disposed within spaces between neighboring or adjacent lockers and may illuminate to define a path or route to the reserved locker from the registering device. In this way, guests may reserve and locate the reserved lockers efficiently, expediting the storage process within the entertainment venue and decreasing congestion.

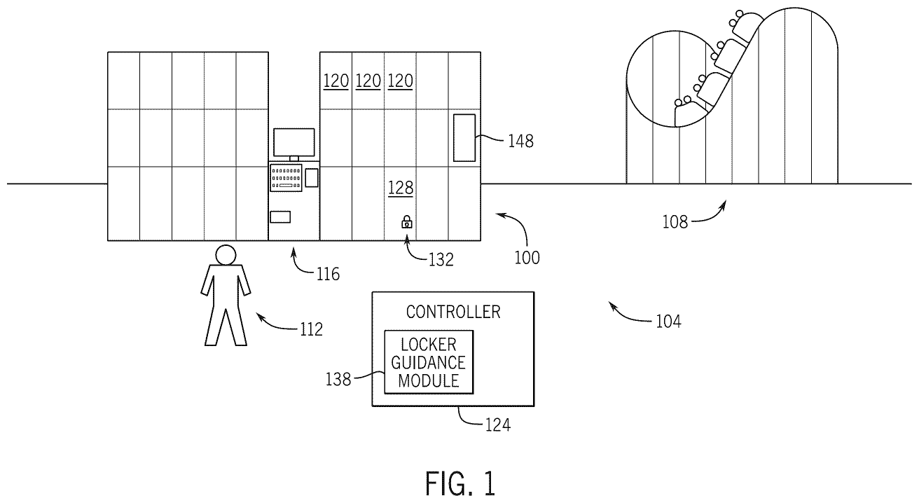

With the foregoing in mind, to demonstrate various aspects of the present disclosure, the present embodiments are described with respect to a locker system that provides lockers to guests (e.g., users and/or personnel) in an entertainment venue, amusement park, or any other suitable facility. Specifically, embodiments of the present disclosure present a solution to efficiently guide guests to their respective reserved lockers. For example, FIG. 1 is a schematic diagram of a locker system 100 in an entertainment venue 104, in accordance with an aspect of the present disclosure. The locker system 100 may be positioned near or proximate to an attraction, such as ride 108, to provide convenient storage to guests 112 participating in the attraction. For example, the locker system 100 may be located at the entry of the ride 108 and/or at the exit of the ride 108 to enable storage before participating in the ride 108, and retrieval after participating in the ride 108. In some instances, the locker system 100 may be located at both the entry and the exit of the ride 108, enabling expedited loading and unloading of belongings into and out of the same locker system 100. For example, the locker system 100 may be two sided, such that a first side is operable to receive belongings from guests 112 entering ride 108 and a second side is operable to provide the belonging to the guests 112 exiting the ride 108.

The locker system 100 may include a registering device 116 (e.g., kiosk, payment station, terminal device, mobile device) operable to manage reserving of a locker 120 of the locker system 100. For example, a guest 112 may request a reserved locker 128 by providing the registering device 116 with an inquiry. In an embodiment, the guest 12 may rent or purchase the reserved locker 128 by providing the registering device 116 with a payment to rent a locker 120 of the locker system 100. Once reserved or once rented, a controller 124 of the locker system 100 may assign a locker of the one or more lockers 120, such as reserved locker 128, to enable storage of personal belongings by the guest 112. In embodiments, the controller 124 may be a part or element of the registering device 116. Each locker 120 of the locker system 100 may include a locking mechanism, such as a suitable actuator 132 operable to lock/unlock and/or open/close the reserved locker 128 upon receiving instructions from the controller 124. In some embodiments, since the controller 124 is communicatively coupled to the lockers 120, the operative condition of the actuators 132 and/or the lockers 120 may be communicated to the controller 124, providing availability information for the lockers 120. That is, the controller 124 may receive information about a state of individual actuators 132 (e.g., locked configuration or unlocked configuration) and/or the lockers 120 and may designate the availability of the associated lockers 120 (e.g., available (e.g., available when the actuator 132 is unlocked) or unavailable (e.g., unavailable when the actuator 132 is locked) accordingly. In an embodiment, the availability of lockers 120 may be based on information stored within the controller 124, such as information related to already assigned and vacant lockers. In an embodiment, the lockers 120 may be designated as available when they are empty (e.g., not reserved) and may be designated as not available when they are reserved and/or rented, filled, designated for repair/maintenance, and/or are previously selected as not available.

In many instances, the locker system 100 may include dozens or hundreds of lockers 120, in one or more rows, which may provide confusion during the locker reservation process. For example, when the guest 112 reserves a locker (e.g., reserved locker 128) from the registering device 116, the registering device 116 may assign the reserved locker relatively far away from the registering device 116, such as, when there are no available lockers 120 close by. As another example, when the guest 112 seeks the reserved locker 128 to retrieve personal items, such as after or upon exit of the ride 108, the guest 112 may experience difficulty and confusion finding the reserved locker 128. Moreover, group loading and group unloading times of the ride 108 or another attraction may provide increased congestion near the locker system 100, such as during storing or receiving of belongings. As such, the locker system 100 may further include a locker guidance module 138 (e.g., locker guidance system, locker guidance instructions stored in memory) of the controller 124 operable to provide direction and guidance to the guests 112 to expedite processes associated with the locker system 100, such as storing and retrieving belongings. For example, the locker guidance module 138 may include instructions operable to guide or direct the guest 112 from the registering device 116 to the reserved locker 128. Additionally or alternatively, the locker guidance module 138 may include instructions operable to present guidance imagery on one or more locker displays 148 of the locker system 100 to facilitate guidance to reserved lockers 128.

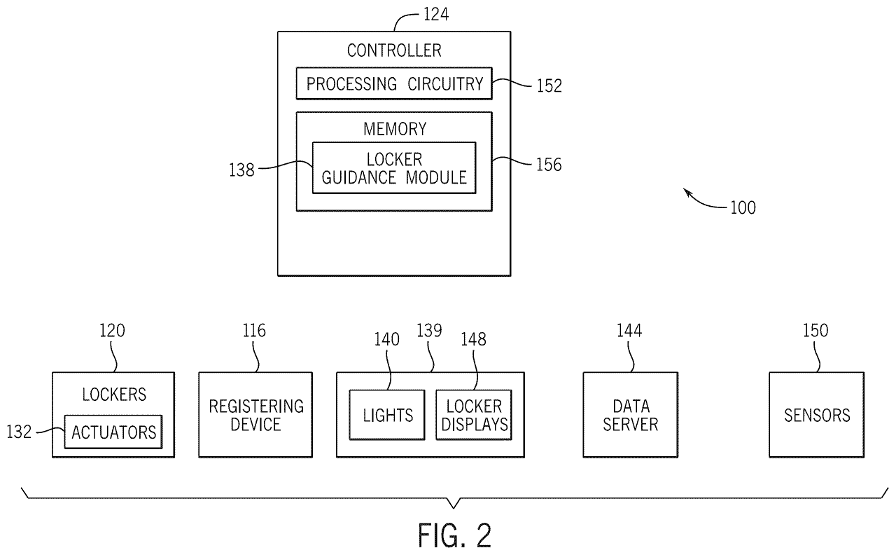

Referring now to FIG. 2, a block diagram of an embodiment of the locker system 100 is illustrated, in accordance with one or more aspects of the present disclosure. As discussed above, the locker system 100 may include a controller 124 operable to facilitate the reservation and storage processes of the locker system 100. The controller 124 may be communicatively coupled to one or more components of the locker system 100 (e.g., lockers 120, actuator 132, registering device 116, lighting system 139 (e.g., lights 140, locker displays 148) data server 144, and/or sensors 150) and is operable to monitor, adjust, and/or otherwise control operation of the components of the locker system 100. For example, one or more control transfer devices, such as wires, cables, wireless communication devices, and the like, may communicatively couple the lockers 120, the actuators 132, the registering device 116, the lights 140, the data server 144, the locker displays 148, sensors 150 and/or any other suitable components of the locker system 100 to the controller 124. That is, the lockers 120, the actuators 132, the registering interface 116, the lights 140, the data server 144, the locker displays 148, and sensors 150 may each have one or more communication components that facilitate wired or wireless (e.g., via a network) communication with the controller 124. In some embodiments, the communication components may include a network interface that enables the components of the locker system 100 to communicate via various protocols such as EtherNet/IP, ControlNet, DeviceNet, or any other communication network protocol. Alternatively, the communication components may enable the components of the locker system 100 to communicate via mobile telecommunications technology, Bluetooth®, near-field communications technology, and the like. As such, the lockers 120, the actuators 132, the registering device 116, the lights 140, the data server 144, the locker displays 148, and sensors 150 may wirelessly communicate data between each other.

In an embodiment, the controller 124 may be operable to control one or more components of the entertainment venue 104 (e.g., an additional locker system 100) in addition to the locker system 100. In an embodiment, the controller 124 may be a standalone controller, a dedicated controller, or another suitable controller included in the locker system 100. In any case, the controller 124 is operable to control components of the locker system 100 in accordance with the techniques discussed herein. The controller 124 may include processing circuitry 152 (e.g., processing system), such as a microprocessor, which may execute software for controlling the components of the locker system 100. The processing circuitry 152 may include one or more processors, such as multiple microprocessors, one or more “general-purpose” microprocessors, one or more special-purpose microprocessors, and/or one or more application specific integrated circuits (ASICS), or some combination thereof. For example, the processing circuitry 152 may include one or more reduced instruction set (RISC) processors.

The controller 124 may also include a memory device 156 (e.g., a memory) that may store information, such as instructions, control software, look up tables, configuration data, etc. The memory device 156 may include a volatile memory, such as random access memory (RAM), and/or a nonvolatile memory, such as read-only memory (ROM). The memory device 156 may store a variety of information and may be used for various purposes. For example, the memory device 156 may store processor-executable instructions including firmware or software for the processing circuitry 152 to execute to cause the processing circuitry 152 to act, such as instructions for controlling components of the locker system 100 (e.g., the lockers 120, the actuators 132, the registering device 116, the lights 140, the data server 144, the locker displays 148, the sensors 150). In some embodiments, the memory device 156 may be a tangible, non-transitory, machine-readable-medium that may store machine-readable instructions for the processing circuitry 152 to execute. The memory device 156 may include ROM, flash memory, a hard drive, or any other suitable optical, magnetic, or solid-state storage medium, or a combination thereof. The memory device 156 may store data, instructions, and any other suitable data. As will be appreciated, instructions of the locker system 100, such as instructions of the locker guidance module 138, may be stored in one or more locations. As such, the memory device 156 may reside in one location or a plurality of locations.

In an embodiment, the memory device 156 may store the locker guidance module 138, including algorithms or rules-based instructions to access, process, and/or analyze information stored in the memory device 156 or the data server 144 (e.g., reserved locker 128 location) as well as data from signal(s) provided by the registering device 116, and/or the sensors 150 as inputs. Based on this accessing, processing, and/or analyzing of the information and/or data, the locker guidance module 138 may generate visual directions to the guest 112 for accessing the reserved locker 128. The generated visual directions may be based on the location of the reserved locker 128, the location of the guest 112, the location of the registering device 116, or a combination thereof. In particular, the locker guidance module 138 may include instructions executable by the processing circuitry 152 to illuminate one or more lights 140 (e.g., a strand of LEDs, an LED panel, array of lights) of the lighting system 139 to define a path to guide the guest 112 from the registering device 116 to the reserved locker 128, during storage or retrieval of belongings.

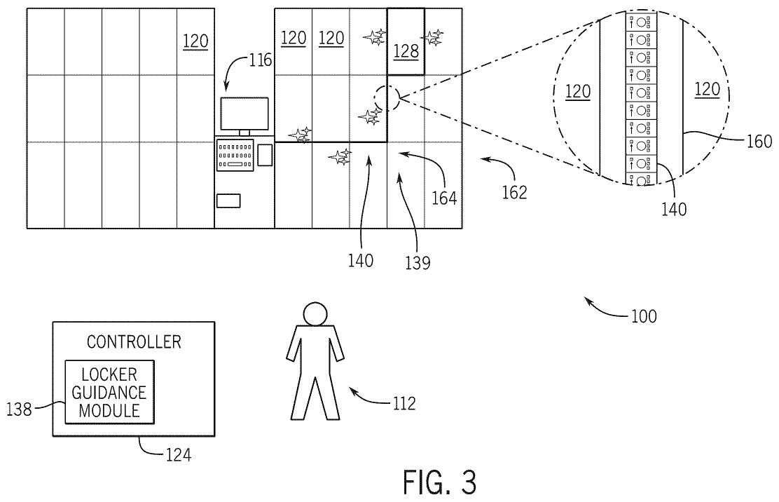

In order to better illustrate the guidance process provided by the locker system 100, FIG. 3 illustrates an embodiment of the locker system 100 having the controller 124 and the locker guidance module 138. In an embodiment, the lockers 120 of the locker system 100 may define, or may be housed by, a front facing frame 162 including one or more locker spaces 160 in between neighboring or adjacent lockers 120. These one or more locker spaces 160 may be defined by portions of the front facing frame 162 of the locker system 100 that are exposed between locker doors. For example, embodiments of the locker system 100 may include multiple rows of lockers 120 abutting one another and/or multiple columns of lockers 120 abutting one another defining the front facing frame 162 or locker grid. The lights 140 may be positioned within the locker spaces 160 between lockers 120 (e.g., coupled or integrated with the frame 162), on the lockers 120, and/or in areas surrounding the locker system 100, such as on the floor supporting the locker system 100, a nearby wall, a ceiling, and so forth. In an embodiment, the lights 140 may be strip lights, such as LED strip lights, operable to continuously run along the locker spaces 160 between the lockers 120 to imitate a line when lit or illuminated. For example, the lights 140 (e.g., part of a lighting system) may be integrated with or attached to the front facing frame 162 (e.g., along the locker spaces 160) to form a matrix of lighting that can be selectively activated. In an embodiment, the lights 140 may be standalone, such as individual LED lights positioned at intervals within the locker spaces 160 between the lockers 120. As will be appreciated, the lights 140 may include any suitable type of lights and are not intended to be limited to the above-mentioned embodiments. In yet another embodiment, the front facing frame 162 of the locker system 100 may include the locker display(s) 148 and portions of the locker display(s) 148 may be controlled to present a lighted pathway to the reserved locker 128 that winds between the lockers 120.

In any case, the lights 140 may be addressable or controllable such that the controller 124 or the locker guidance module 138 may provide directional assistance, guiding the guest 112 to the reserved locker 128. For example, the controller 124 may execute instructions of the locker guidance module 138 to illuminate a selected portion of the lights 140 (e.g., portions of the lights 140 that extend along the locker spaces 160 between the lockers 120 to the reserved locker 128) to define a path 164 to the reserved locker 128. In embodiments, the path 164 may extend from the registering device 116 to the reserved locker 128 in order to guide the guest 112 originally located at the registering device 116 to the reserved locker 128. The path 164 may be defined by lights 140 extending through the locker spaces 160 between the lockers 120, on the lockers 120 (e.g., on the face of the lockers 120), and/or along areas nearby the locker system 100, such as adjacent floors, walls, ceilings, canopies, etc. Additionally or alternatively, illuminated lights 140 may surround or cover the reserved locker 128 (e.g., a perimeter of the reserved locker 128) to further provide direction assistance and expedite the storage process.

In an embodiment, upon reaching the reserved locker 128, the locker system 100 may verify the guest 112 prior to opening the reserved locker 128. For instance, the locker system 100 may utilize facial recognition to match or otherwise verify that the guest 112 at the registering device 116 is the guest 112 at the reserved locker 128. Additionally or alternatively, the locker system 100 may utilize one or more signals from a guest device (e.g., a cellular device) to verify the guest 112 at the registering device 116 is the guest 112 at the reserved locker 128. In an embodiment, the registering device 116 may provide a verification code (e.g., passcode, barcode) for input (e.g., input into a reserved locker manual or digital lock, input into a reserved locker interface) and/or presentation (e.g., to a scanner) at the reserved locker 128. Upon verification at the reserved locker 128, the reserved locker 128 may be instructed to unlock and open to receive items.

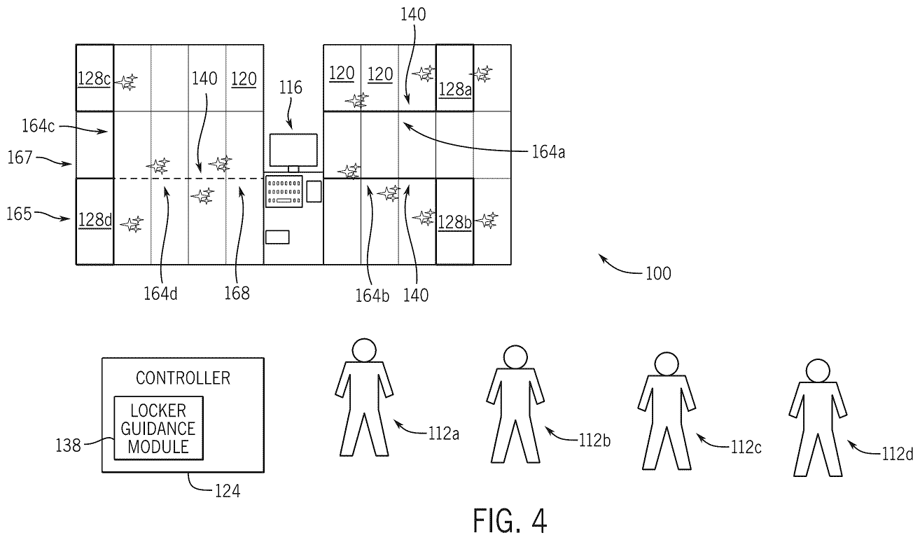

FIG. 4 is a schematic diagram of yet another embodiment of the locker system 100 in accordance with an aspect of the present disclosure. Certain elements of the components are omitted in the illustrated embodiment for clarity, but it should be appreciated that the components of the locker system 100 in the illustrated embodiment may be similar to those described above with reference to FIGS. 1, 2, and 3, and/or may include similar elements.

As will be appreciated, the locker guidance module 138 may include instructions to generate many different variations (e.g., routes, visual characteristics) of the path 164 by selectively illuminating lights 140. For example, the controller 124 may illuminate lights 140 to extend or route the path 164 in any suitable direction to provide guidance to the guest 112 from the registering device 116 to the reserved locker 128. In an embodiment, the path 164 route may depend on or may be partially based on a guest 112 characteristic or status (e.g., obtained from a guest profile within data server 144). For example, locker guidance module 138 may include instructions to generate the path 164 generally along a lower height, such as along the first row of lockers 120, based on data or information received from the guest 112 profile (e.g., within data server 144) indicative of a short height or young age. Similarly, the locker guidance module 138 may include instructions to generate the path 164 generally along a higher height, such as along the third row of lockers 120, based on data or information received from the guest 112 profile (e.g., within data server 144) indicative of a tall height. It should be noted that the locker guidance module 138 may activate the lights 140 to create the illusion of flow toward the reserved locker 128.

In an embodiment, the path 164 may change in real-time based on additional paths, lockers in use (e.g., open lockers, lockers being locked, lockers with guests nearby), damaged lights, and/or other conflicting scenarios. For example, in many instances, two or more guests, such as guest 112a and guest 112b, may be using the locker system 100 during overlapping times. For instance, the guest 112a may purchase the reserved locker 128a for storage of personal belongings during the same time as guest 112b is retrieving belongings from reserved locker 128b. In order to reduce confusion and facilitate efficient direction of the guests 112a, 112b to each respective reserved locker 128a, 128b, the locker guidance module 138 may include instructions operable to alter the respective paths 164a when a conflict occurs. In an embodiment, the locker guidance module 138 may include instructions that, when executed, are operable to separate different paths 164 when the different paths 164 overlap (e.g., paths to immediately adjacent or nearby lockers). For example, in the illustrated embodiment, upon a determination that two or more guests (e.g., guest 112a, guest 112b) are engaged in storing or unloading to/from a reserved locker (e.g., reserved locker 128a, 128b, respectively), the locker guidance module 138 may provide instructions that, when executed, are operable to separate or redirect the path 164a from path 164b such that there is no overlap of the path 164a with the path 164b. For example, the controller 124 may generate the path 164a to extend along the top row of lockers 120 and the path 164b to extend along the bottom row of lockers 120. As will be appreciated, the locker guidance module 138 may include instructions to change or redirect the route of the path 164 before or after the original generation of the path 164.

In an embodiment, the locker guidance module 138 may include instructions that, when executed, are operable to provide paths 164 including different light characteristics to reduce confusion and facilitate efficient guest direction. For example, the controller 124 may execute instructions from the locker guidance module 138 to control the lights 140 defining the paths 164 to include different colors, different intensities, different light patterns, other light characteristics, or a combination thereof. In the illustrated embodiment, the path 164a may include a first color, a first light intensity, and a first light pattern (e.g., alternating colors, solid line, dotted line, etc.) while the path 164b may include a second color, a second light intensity, and a second light pattern, where at least one light characteristic of the path 164a is different than at least one light characteristic of the path 164b. By generating the different paths 164a, 164b to have visually distinct characteristics, the locker guidance module 138 may facilitate quick differentiation of the paths 164a, 164b by the guests 112a, 112b. This may allow the guests 112a, 112b to efficiently find their respective reserved lockers 128a, 128b.

In an embodiment, the locker guidance module 138 may include instructions that, when executed, are operable to provide a cooperative path 168 (e.g., combined path, partially combined path) with light characteristics corresponding to two or more paths 164 to reduce confusion and facilitate efficient guest direction. The cooperative path 168 may be a full path or a portion of a path that is used to direct more than one guest to their respective reserved locker 128. To reduce confusion, the controller 124 may execute instructions from the locker guidance module 138 to control the lights 140 defining the cooperative path 168 to include colors, light intensities, light patterns, and/or other light characteristics, associated with two or more of the paths 164. For example, the lights 140 may illuminate blue to define path 164c operable to provide visual direction or guidance for a guest 112c to a reserved locker 128c. Lights 140 may illuminate red to define path 164d operable to provide visual direction or guidance for a guest 112d to a reserved locker 128d. In the illustrated embodiment, the paths 164c and 164d may overlap in between a first row 165 of the locker system 100 and a second row 167 of the locker system 100, creating the cooperative path 168. In the present example, the locker guidance module 138 may include instructions that, when executed, are operable to generate the cooperative path 168 with blue (corresponding to the path 164c) and red (corresponding to the path 164d) colors. Specifically, the lights 140 defining the cooperative path 168 may flash or blink blue and red colors, may include alternating blue and red lights, may illuminate a mixed color (e.g., purple), and/or another suitable light combination. The cooperative path 168 is not limited to a combination of two paths 164, and it will be appreciated the cooperative paths 168 may include any number of paths 164.

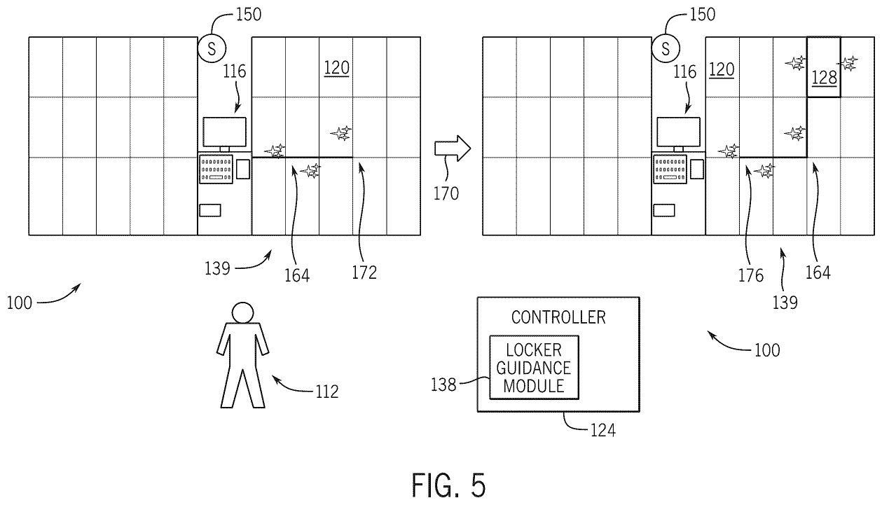

FIG. 5 is a schematic diagram of yet another embodiment of the locker system 100 in accordance with an aspect of the present disclosure. Certain elements of the components are omitted in the illustrated embodiment for clarity, but it should be appreciated that the components of the locker system 100 in the illustrated embodiment may be similar to those described above with reference to FIGS. 1, 2, 3, and 4 and/or may include similar elements.

In FIG. 5, the path 164 is depicted as dynamic, wherein the arrow 170 represents transition through time and facilitates illustration of how the path 164 is presented by the lights 140 over a timeframe. The path 164 may extend to the reserved locker 128 from the registering device 116 in any suitable manner. For example, in response to assignment of the reserved locker 128 to the guest 112 (e.g., based on a request from the guest 112), the controller 124 including the locker guidance module 138 may be operable to illuminate lights 140 to define the entire path in real-time. While, in an embodiment, the locker guidance module 138 may include instructions that, when executed, are operable to generate the path 164 to appear in its entirety upon assignment of the reserved locker 128 at the registering device 116, the illustrated embodiment of FIG. 5 is dynamic and partially presents during different times.

In an embodiment, the locker guidance module 138 may include instructions that, when executed, are operable to generate the path 164 in portions or segments over a period of time, to further facilitate guiding of the guest 112 to the reserved locker 128. In other words, the path 164 may be presented to dynamically lead the guest 112 or, in other words, perform as a moving guide. For example, upon assignment of the reserved locker 128 (e.g., based on a request from the guest 112), the controller 124 including the locker guidance module 138 may be operable to illuminate lights 140 to define segments of the path 164 over a period of time (as depicted by the arrow 170). For example, the path 164 may include a path head 172, on one end of the path 164, that lights up to indicate that the guest 112 should move away from the registering device 116 upon assignment of the reserved locker 128 by the controller 124. The remaining portion of the path 164 may be lit subsequent to lighting the path head 172 to enable continued guidance for the guest 112. In an embodiment, the path head 172 may extend across lockers 120 based on a predetermined formula or equation. For example, the path head 172 may extend across a predetermined number of lockers 120 (e.g., 1 locker 120, 2 lockers 120, 3 lockers 120) during a determined time period (e.g., 1 second, 2, seconds, 3 seconds, etc.) In an embodiment, the predetermined formula may be partially based on a walking speed of the guest 112 (e.g., a measured speed for a particular guest or an average walking speed for most guests).

In an embodiment, the path head 172 may extend or move across the lockers 120 based on a position of the guest 112. For example, as the guest 112 moves along the path 164, the path head 172 may advance towards the reserved locker 128, and when the guest 112 is not moving, the path head 172 may halt. To this end, the lockers system 100 may include one or more sensors 150 operable to detect a position of the guest 112 relative to the registering device 116, the path head 172, the path 164, the reserved locker 128, and/or another component of the locker system 100. The sensors 150 may be operable to detect and transmit the location of the guest 112 to the controller 124 via any suitable communication method. Based on the location of the guest 112, the controller 124 may advance, stop, or retreat the path 164 to enable efficient guidance of the guest 112. Specifically, the controller 124 may send a signal to illuminate the lights 140 to define the path head 172 and/or the remaining portion of the path 164 at a determined location on the locker system 100, based on the location of the guest 112. The sensors 150 may include any suitable sensors operable to detect a location of a human or group of humans, such as, infrared sensors, light detection and ranging sensors (LiDAR), video motion detection sensors, RFID sensors, and so forth. It should be noted that activation of the lights 140 to present the path 164 may be controlled to achieve various different visual and functional results (e.g., a path that gradually grows to completion, a path that extends toward the reserved locker 128 with portions of the path that are beyond a threshold distance behind being erased, a fully lit pathway with a portion that lights up differently adjacent to the location of the guest 112, and so forth).

For example, in an embodiment, the path 164 may include what may be referred to as a path tail 176 at an end of the path 164, opposite the end of the path 164 referred to as the path head 172. In an embodiment, the path tail 176 may follow the path 164 across lockers 120 based on a predetermined formula or equation. For example, the path tail 176 may follow the path 164 after a predetermined period of time has passed to recede or retreat the path 164 (e.g., the lights 140 may be turned off or “erased” after a predetermined period of time has passed). In this way, by receding the path 164, the number illuminated lights 140 within the locker system 100 during a single time period may be reduced, reducing guest confusion. By way of example, the path 164 including path head 172 and path tail 176 may imitate a moving snake. In an embodiment, the receding of the path 164, or the advancing of the path tail 176, may be based on a number of guests using the locker system 100. For example, upon a determination that the number of guests 112 within the locker system 100 area (e.g., based on data received from sensors 150) is over a threshold number, the controller 124 may be operable to retreat or recede the path 164, reducing the number of lights 140 illuminated. Upon a determination that the number of guests 112 within the locker system 100 area is below a threshold number, the controller 124 may be operable to retain the path 164 during the guest's use of the locker system 100. In an embodiment, the movement of the path tail 176 may be partially based on the movement of the path head 172.

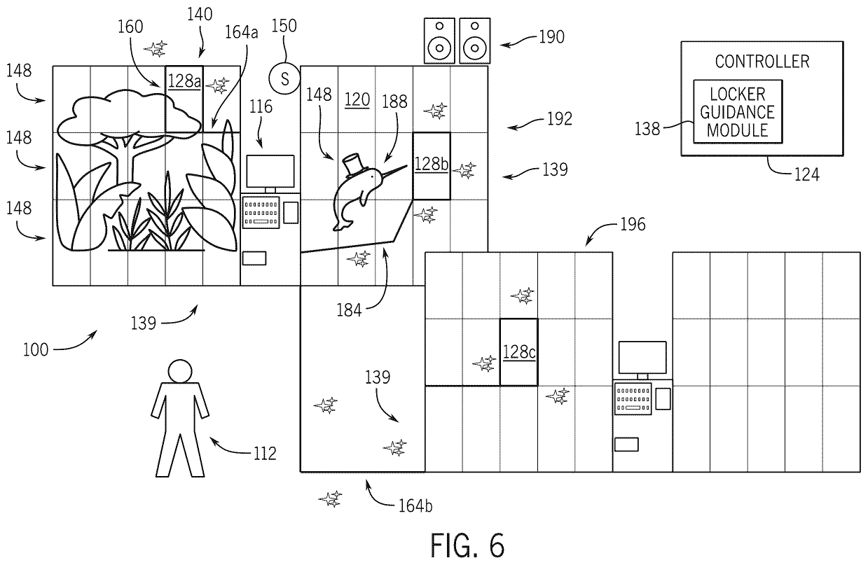

FIG. 6 is a schematic diagram of yet another embodiment of the locker system 100 in accordance with an aspect of the present disclosure. Certain elements of the components are omitted in the illustrated embodiment for clarity, but it should be appreciated that the components of the locker system 100 in the illustrated embodiment may be similar to those described above with reference to FIGS. 1, 2, 3, 4, and 5 and/or may include similar elements.

In an embodiment, the locker system 100 may be operable to display imagery to the guest 112 to further enhance the guest experience and/or guide the guest 112 to the reserved locker 128. To this end, as discussed above, the lighting system 139 of the locker system 100 may include the one or more locker displays 148 (e.g., screens, touchscreens, graphical displays), in addition to or alternative to the lights 140, operable to present imagery to the guest 112. For example, each door of the lockers 120 may include a locker display of the one or more locker displays 148, such as a liquid crystal display (LCD), light emitting diode (LED) display, organic light emitting diode (OLED) display, and so forth. For example, each locker display of the one or more locker displays 148 may form a boundary (e.g., enclosure boundary, compartment boundary, confines) of each locker of the one or more lockers 120. In an embodiment, the boundary may include substantially the same dimensions or similar dimensions to a door of a locker of the one or more lockers 120. In an embodiment, the controller 124 may be operable to provide instructions to the locker displays 148 to display a single image using one display of the one or more locker displays 148 or a combined image utilizing multiple locker displays of the one or more locker displays 148. That is, the controller 124 may instruct each locker display 148 to display a portion of a desired image, such a portion of the jungle imagery in the illustrated embodiment.

In an embodiment, the locker system 100 may be operable to provide themed imagery to disguise or enhance the immersive aesthetic of the locker system 100. In the illustrated embodiment, the controller 124 may instruct locker displays 148 to provide jungle imagery on the face of the lockers 120 to create an immersive experience associated, for example, with a jungle ride attraction. In another instance, the controller 124 may instruct locker displays 148 to provide bricked imagery on the face of the lockers 120 to disguise the locker system 100 against, for example, a brick wall, when the locker system 100 is not in use. By providing locker displays 148 on the locker system 100, an overall aesthetic of the surrounding area may be increased.

As will be appreciated, the displayed imagery provided by the locker displays 148 of the locker system 100 may operate in addition or alternative to the lights 140. In an embodiment, the controller 124 may be operable to provide instructions to the locker displays 148 to provide imagery (e.g., themed imagery) in addition to generating the path 164 defined by lights 140 (e.g., LED strips, spaced-apart LEDs). For example, the locker guidance module 138 may include instructions that, when executed, cause the lights 140 to generate the path 164 from the registering device 116 to the reserved locker 128a around the locker displays 148 (e.g., within locker spaces 160) to enable presentation of the displayed imagery while enabling guidance via the path 164. In an embodiment, the path 164 (specifically light characteristics of the path 164) may be associated with the displayed imagery on the locker displays 148. For example, the lights 140 defining the path 164 may include light characteristics that enhance or are otherwise associated with the displayed imagery, such as themed imagery. For instance, the locker displays 148 may be operable to present themed imagery corresponding to a volcano or another lava like scene, and the path 164 may be illuminated by the lights 140 to provide a red color or shade, to imitate or give the illusion of lava flowing through the lockers 120.

In some embodiment, the locker displays 148 may generate guiding imagery to the guest 112 to enable guidance to the reserved locker 128. For example, the locker guidance module 138 may include instructions that, when executed, activate generation of a displayed path 184 on the locker displays 148 extending from the registering device 116 towards or to the reserved locker 128. In some instances, the displayed path 184 may include any suitable imagery. This imagery is not limited to the line shown in the illustrated example. For example, the presentation of the displayed path 184 may be associated with a theme of the locker system 100 and/or an associated attraction (e.g., ride 108). In the present example, the displayed path 184 may include imagery (e.g., animation) relating to a jungle, such a vine extending from the registering device 116 to the reserved locker 128b. In an embodiment, the displayed path 184 may be used in addition to the path 164 defined by a different type of the lights 140. For example, the path 164 defined by lights 140 may be combined with the displayed path 184 presented on the locker displays 148 to define a combined path.

In an embodiment, the locker displays 148 may be operable to generate guiding imagery such as a displayed guide 188 in addition or alternative to the displayed path 184 or path 164. For example, the displayed guide 188 may include a displayed image that is operable to lead or guide the guest 112 to the reserved locker 128 from the registered device 116. For example, the displayed guide 188 may be an animated character (e.g., a character associated with the entertainment venue), an inanimate object (e.g., arrow), or another suitable object operable to move across the locker displays 148 to the reserved locker 128. In an embodiment, the displayed guide 188 may be generated based on a guest profile. For example, the guest 112 may include a favorite or preferred animated character indicated within the guest profile associated with the guest 112. The controller 124 may be operable to access the guest profile (e.g., within the data server 144) to generate the displayed guide 188 based on the guest profile. In the illustrated embodiment, the displayed guide 188 may be a fanciful narwhal, which may be the guest's favorite or chosen animated character indicated within the guest profile.

In an embodiment, the displayed guide 188 may “move” or may be displayed on the locker displays 148 based on a position of the guest 112. As similarly described above, as the guest 112 is directed or moves toward the reserved locker 128, the displayed guide 188 may advance towards the reserved locker 128, and when the guest 112 is not moving, the displayed guide 188 may halt. The sensors 150 may be operable to detect and transmit the location of the guest 112 to the controller 124, and based on the location of the guest 112, the controller 124 may advance, stop, or retreat the displayed guide 188 to enable efficient guidance of the guest 112. In an embodiment, the locker system 100 may include one or more speakers 190 operable to facilitate guidance of the guest 112. In an embodiment, the locker guidance module 138 may include instructions operable to instruct the speakers 190 to provide audio to the guest 112 based on the location of the guest 112. For example, the locker guidance module 138 may include instructions operable to instruct the speakers 190 to output words or phrases, such as “You are going the wrong way!” when the guest's location is moving away from the reserved locker 128, as determined by the sensors 150. In another example, the locker guidance module 138 may include instructions operable to instruct the speakers 190 to output words or phrases, such as “Over here!” “You are close!” or “Follow me!”. In some embodiments, the audio outputted by the speakers 190 may be associated with the displayed guide 188. For example, the audio outputted by the speakers 190 may imitate a voice of the displayed guide 188, such as the guest's favorite animated character. Directional speakers may be employed as the speakers 190 to increase immersion by making audio seem to originate from the displayed guide 188.

In an embodiment, the locker system 100 may include more than one area of lockers 120, such as multiple locker banks. In some instances, the registering device 116 of one locker bank, such as a first locker bank 192, may assign the reserved locker 128 located within another locker bank, such as a second locker bank 196, for example, when there are no available locker banks in the first locker bank 192. In order to efficiently guide the guest 112 from the first locker bank 192 to the second locker bank 196, the locker system 100 may extend the path 164 to the second locker bank 196. For example, the lights 140 may be disposed in areas surrounding the locker banks 192, 196 of the locker system 100, and are operable to define the path 164 in the surrounding areas. In the illustrated embodiment, the locker guidance module 138 may include instructions that, when executed, cause the lights 140 to illuminate to define path 164b partially positioned on a floor between the first and second locker banks 192, 196 to guide the guest 112 between banks. In some embodiments, the lights may be positioned on surrounding walls, ceilings, canopies, and/or other structural features near the locker system 100.

In an embodiment, the locker system 100 may provide instructions to operate the reserved locker 128 to the guest 112 when the guest reaches the reserved locker 128. For example, the locker display 148 of the reserved locker 128 may present instructions on how to open, close, and lock the reserved locker 128. For instance, upon determining the guest 112 has reached the reserved locker 128, the controller 124 may instruct the locker display 148 corresponding to the reserved locker 128 to display instructions corresponding to operation of the reserved locker 128. Upon determining the guest 112 has moved away from the reserved locker 128, or successfully operated the reserved locker 128 (e.g., opened reserved locker 128, locked reserved locker 128), the controller 124 may instruct the locker display 148 corresponding to the reserved locker 128 to turn off or display other imagery (e.g., themed imagery, advertisements, attraction survey).

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-6 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A locker system for an entertainment venue, the locker system comprising:
a frame and one or more lockers housed within the frame, each of the one or more lockers comprising a corresponding locking mechanism and a corresponding actuator;
a lighting system supported by the frame and adjacent to the one or more lockers;
a registering device configured to receive a request for a locker assignment from a guest;
a processing system comprising one or more processors; and
memory storing instructions configured to be executed by the processing system to cause the processing system to:
assign a reserved locker of the one or more lockers to the guest based on the request;
activate a locker guidance module to control illumination of the lighting system to define a spatial route from the registering device to the reserved locker; and
control the corresponding actuator of the reserved locker to actuate the corresponding locking mechanism of the reserved locker.

2. The locker system of claim 1, wherein the lighting system comprises an array of lights coupled or integrated with the frame and positioned between doors of the one or more lockers.

3. The locker system of claim 1, wherein a first locker of the one or more lockers and a second locker of the one or more lockers define a locker space of the frame, and at least a portion of one or more lights of the lighting system are coupled to or within the locker space.

4. The locker system of claim 1, wherein one or more lights of the lighting system are addressable lights.

5. The locker system of claim 1, wherein the lighting system comprises one or more locker displays.

6. The locker system of claim 1, wherein the guest is a first guest, the spatial route is a first spatial route, the reserved locker is a first reserved locker, and wherein the instructions are configured to be executed by the processing system to cause the processing system to activate the locker guidance module to define a second spatial route from the registering device to a second reserved locker associated with a second guest.

7. The locker system of claim 6, wherein the instructions are configured to be executed by the processing system to cause the processing system to separate the first spatial route from the second spatial route.

8. The locker system of claim 6, wherein the first spatial route and the second spatial route overlap to form a cooperative spatial route, and wherein the instructions are configured to be executed by the processing system to cause the processing system to activate the locker guidance module to illuminate the lighting system to define the cooperative spatial route.

9. The locker system of claim 8, wherein the first spatial route comprises a first color, the second spatial route comprises a second color, and the cooperative spatial route comprises a combination of the first color and the second color.

10. The locker system of claim 1, wherein the spatial route is configured to extend around the reserved locker to at least partially define a perimeter of the reserved locker.

11. The locker system of claim 1, wherein the instructions are configured to be executed by the processing system to cause the processing system to activate the locker guidance module to illuminate the lighting system to define the spatial route with characteristics based on a guest profile associated with the guest.

12. The locker system of claim 1, wherein the registering device includes a kiosk or a user interface on a mobile device.

13. The locker system of claim 1, wherein the instructions are configured to be executed by the processing system to cause the processing system to activate the locker guidance module to illuminate the lighting system to redirect the spatial route around a locker in use, wherein the locker in use is a locker of the one or more lockers.

14. A locker system for storing belongings, the locker system comprising:
one or more lockers, each of the one or more lockers comprising a corresponding locking mechanism and a corresponding actuator;
a registering device configured to assign a reserved locker of the one or more lockers to a guest;
locker displays positioned on an outside of the one or more lockers; and
a processing system comprising one or more processors; and
memory storing instructions configured to be executed by the processing system to cause the processing system to:
display, via the locker displays, guiding imagery to direct the guest from the registering device to the reserved locker; and
control the corresponding actuator of the reserved locker to actuate the corresponding locking mechanism of the reserved locker.

15. The locker system of claim 14, wherein the guiding imagery comprises a displayed spatial route extending from a portion of the locker displays proximate the registering device to the reserved locker.

16. The locker system of claim 14, wherein the guiding imagery is a displayed guide that is animated to lead the guest from the registering device to the reserved locker.

17. The locker system of claim 16, wherein the displayed guide is an animated character generated based on a guest profile.

18. The locker system of claim 14, wherein the locker displays are configured to display instructions to operate the one or more lockers.

19. A locker system for an entertainment venue, the locker system comprising:
a frame and one or more lockers housed within the frame, each of the one or more lockers comprising a corresponding locking mechanism and a corresponding actuator;
a lighting system supported by the frame and adjacent to the one or more lockers; and
a controller communicatively coupled to the lighting system, wherein the controller comprises:
a processing system comprising one or more processors; and
memory storing instructions configured to be executed by the processing system to cause the processing system to:
assign a reserved locker of the one or more lockers to a guest based on a request;
generate a spatial route using the lighting system, wherein the spatial route extends towards the reserved locker; and
control the corresponding actuator of the reserved locker to actuate the corresponding locking mechanism of the reserved locker.

20. The locker system of claim 19 comprising a sensor communicatively coupled to the controller, wherein the sensor is configured to detect a location of the guest relative to the reserved locker, wherein the instructions, when executed by the processing system, cause the processing system to generate the spatial route based on the location of the guest.
